(19) United States
(12) Patent Application Publication
(10) Pub. No.: US 2005/0091892 A1
(43) Pub. Date: May 5, 2005

(54) Baby alert

(76) Inventor: Mike Dang, Las Vegas, NV (US)

Correspondence Address: Mike Phi Dang, 6935 Flowering Willow Street, Las Vegas, NV, 89148, US

(21) Appl. No.: 10/697,933

(22) Filed: Oct. 31, 2003

(51) Int. Cl. G09F 21/04

(52) U.S. Cl. 40/593

(57) ABSTRACT

This Baby Alert device is used to remind the driver of the vehicle that their child or baby is in the back seat. This device is to be placed by the buyer in the middle of the dashboard of the vehicle. It must be visible to the driver. When it is not in use, the device can be fold down by the driver.

### CROSS-REFERENCE TO RELATED APPLICATION

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

This device is to remind the driver that their child or baby is in the backseat of the vehicle. There is no other device currently on the market that reminds the driver of the vehicle that their child or baby is in the back seat. Every summer, a child or baby have died from heat after being forgotten inside the vehicles. It is to be attached by adhesive tape at bottom of the device and will be place in middle of dash board whereby it is clearly visible to the driver of the vehicle.

### BRIEF DESCRIPTION OF THE SEVERAL VIEWS OF THE DRAWING

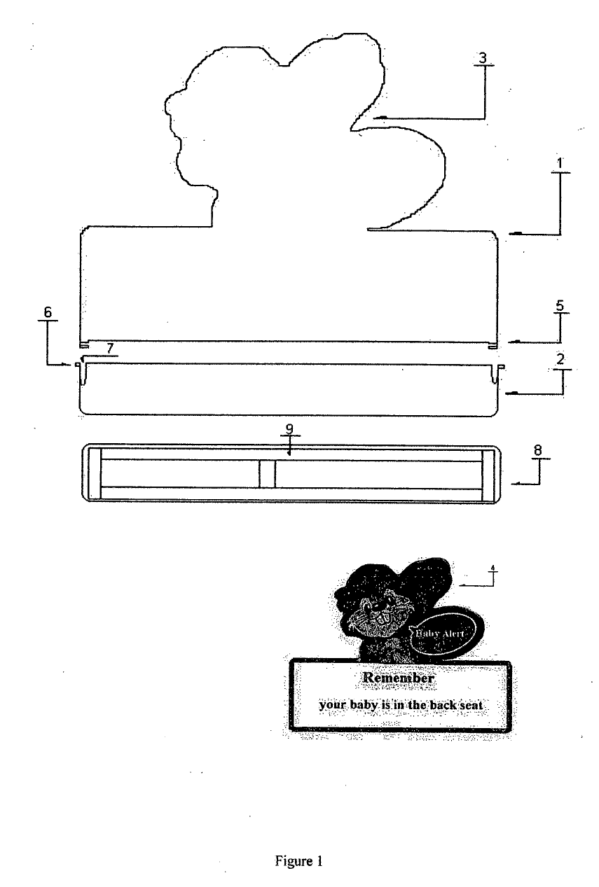

FIG. 1
1. Front Board
2. Support Board
3. Animal Area
4. Animal (Peel Able Glue Paper) The design shall be protected
5. Hinge, Shall be protected
6. Hinge Roll, Shall be protected
7. U-Spring, Shall be protected
8. Back of Support Board

9. Tape of Double Side Glue

### DETAILED DESCRIPTION OF THE INVENTION

This is made of ABS plastic. The sign folds through hinge the connected to the flat platform. It will be four inches long and one and half inches high, it will appears like rectangle. The word inside the sign will say “Remember your baby is in the back seat”. This will be ⅛ inch thick.

A design of a beaver will be on top and attached to the sign. Words coming out the beaver will say “Baby Alert”. This will be two inches high and two inches long. This will be ⅛ inch thick.

The beaver and sign are on a hinge that is attached to a flat platform. The beaver and sign can fold down and up to a three inch platform. Under the platform is a self adhesive tape. The platform is ⅛ inch thick.

The device ia attached to the dashboard of the vehicle. This should be in clear view to the driver.

1. I claim the Baby Alert device is to remind the driver of the car from leaving their child or baby from the back seat of their vehicle.
